(19) United States
(12) Patent Application Publication
(10) Pub. No.: US 2025/0269989 A1
(43) Pub. Date: Aug. 28, 2025

(54) Modified Antenna Ground Plane For Space-Constrained Designs

(71) Applicant: Skydio, Inc., San Mateo, CA (US)

(72) Inventors: Umar Hasni, Redwood City, CA (US); Eyal Hochdorf, Palo Alto, CA (US); Shun Yao, Fremont, CA (US)

(21) Appl. No.: 19/066,251

(22) Filed: Feb. 28, 2025

Related U.S. Application Data
(60) Provisional application No. 63/558,860, filed on Feb. 28, 2024.

(51) Int. Cl. B64U 20/83; B64U 10/14; H01Q 1/28; H01Q 5/307; H01Q 9/04

(52) U.S. Cl. CPC B64U 20/83; B64U 10/14; H01Q 1/28; H01Q 5/307; H01Q 9/0414; B64U 2201/20

(57) ABSTRACT

Described herein are unmanned aerial vehicles (UAVs) and antenna assemblies thereof for shaping radiation patterns in global positioning system applications. For example, an embodiment pertains to an antenna assembly onboard an aerial vehicle. The antenna assembly includes a radiating element coupled to a chassis of an aerial vehicle and positioned in parallel with the chassis, a substrate coupled to the radiating element, a ground plane coupled to the substrate, and a feed cable coupled to the radiating element through the substrate and the ground plane. The ground plane includes a center portion in parallel with the chassis and with the radiating element, and side portions positioned at an angle relative to the chassis and to the radiating element.

### CROSS-REFERENCE TO RELATED APPLICATION

This application claims priority to U.S. Provisional Patent Application No. 63/558,860 filed on Feb. 28, 2024, which is incorporated herein by reference in its entirety for all purposes.

### TECHNICAL FIELD

Various embodiments of the present technology relate to unmanned aerial vehicles (UAVs), and in particular, to antenna design thereof.

### BACKGROUND

Global Positioning System (GPS) capabilities are important for vehicle navigation, vehicle tracking, and other applications requiring precise geolocation information. GPS technology relies on satellite signals to determine a vehicle's exact location and velocity relative to time. To enable GPS capabilities, a vehicle includes a GPS receiver system designed to receive and process the satellite signals and calculate the vehicle's three-dimensional position (latitude, longitude, and altitude) on Earth. Specifically, the GPS receiver system includes an antenna capable of receiving the satellite signals, as well as a processor capable of calculating the vehicle's position using the satellite signals via techniques, such as trilateration.

An example of an antenna used in a GPS receiver system is a patch antenna. A patch antenna is a type of directional antenna commonly used in wireless communication applications, such as in Wi-Fi, GPS, and satellite communication applications. The patch antenna functions based on principles of electromagnetic wave propagation and resonance and typically includes conductive plates separated by a dielectric material that, based on their collective design, cause the patch antenna to become resonant within a specific frequency range.

Some vehicles that include GPS receiver systems have small design spaces and must meet weight or size requirements to function, impacting the design of the patch antenna of the GPS receiver system, and thus, affecting the desired frequency range and efficiency of the patch antenna. For example, unmanned aerial vehicles (UAVs) (e.g., drones) have a small design footprint relative to automobiles, airplanes, and other vehicles that include GPS receiver systems. The UAV footprint might limit the size of the conductive plates of the patch antenna to ensure the patch antenna fits inside the UAV. In turn, limiting the size of the conductive plates may reduce the antenna's ability to convert electrical energy into radiating energy, which may decrease the antenna's gain and efficiency and negatively affect the capabilities of the GPS receiver system.

### Overview

An aerial vehicle is disclosed herein that utilizes an antenna assembly for wireless communication purposes having an angled or curved conductive ground plane to fit a limited design area within the aerial vehicle without sacrificing operational characteristics, such as gain and efficiency, of the aerial vehicle.

In an embodiment, an aerial vehicle is provided that includes a body including a chassis and a frame affixed to the chassis, a plurality of rotor assemblies, a plurality of rotor arms, each rotor arm having a distal end, and a proximal end structurally coupled to the body and a rotor assembly of the plurality of rotor assemblies structurally coupled to the distal end, and an antenna assembly. The antenna assembly includes a radiating element positioned in parallel with the chassis, a substrate coupled to the radiating element, a ground plane coupled to the substrate, and a feed cable coupled to the radiating element through the substrate and the ground plane. The ground plane includes a center portion in parallel with the chassis and with the radiating element, and side portions positioned at an angle relative to the chassis and to the radiating element. It may be appreciated that other representations of the disclosed technology herein can include further systems, computing apparatuses, and methods of manufacturing or assembly elements of an aerial vehicle.

This Overview is provided to introduce a selection of concepts in a simplified form that are further described below in the Detailed Description. This Overview is not intended to identify key features or essential features of the claimed subject matter, nor is it intended to be used as an aid in determining the scope of the claimed subject matter.

While multiple embodiments are disclosed, still other embodiments of the present technology will become apparent to those skilled in the art from the following detailed description, which shows and describes illustrative embodiments of the invention. As will be realized, the technology is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present technology will be described and explained through the use of the accompanying drawings.

FIG. 1 illustrates an exemplary operating architecture of an unmanned aerial vehicle in which some embodiments of the present technology may be utilized.

FIG. 2 illustrates an exemplary operating architecture of an unmanned aerial vehicle in which some embodiments of the present technology may be utilized.

FIG. 3 illustrates aspects of an antenna assembly of an unmanned aerial vehicle in which some embodiments of the present technology may be utilized.

FIG. 4 illustrates an example radiation pattern produced by an antenna assembly of an unmanned aerial vehicle in which some embodiments of the present technology may be utilized.

FIG. 5 illustrates an aspect of an antenna assembly of an unmanned aerial vehicle in which some embodiments of the present technology may be utilized.

FIG. 6 illustrates example electrical field patterns produced by an antenna assembly of an unmanned aerial vehicle in which some embodiments of the present technology may be utilized.

FIG. 7 illustrates example antenna gain patterns produced by an antenna assembly of an unmanned aerial vehicle in which some embodiments of the present technology may be utilized.

FIG. 8 illustrates an example waveform related to antenna gain and frequency of an antenna assembly of an unmanned aerial vehicle in which some embodiments of the present technology may be utilized.

FIG. 9 is a flowchart illustrating an exemplary process for manufacturing or assembly an antenna assembly in accordance with some embodiments of the present technology.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Technology is disclosed herein that mitigates the problems discussed with respect to antenna design and performance in space-constrained areas by slanting, angling, curving, or otherwise shaping portions of a ground plane of an antenna to fit within a space-limited area (in at least one dimension) while maintaining a target radiation pattern and operating frequency of the antenna. While many of the embodiments described herein relate to aerial vehicles, the antenna design and radiation-shaping techniques may be applicable to various other applications and devices, such as other types of vehicles and other types of antennas utilizing conductive ground planes.

In various embodiments, a UAV includes a body or frame that supports a propulsion system for flight, one or more antenna assemblies for wireless communications, and a flight control system, among other systems and devices. The flight control system onboard the UAV communicates with remote receivers using the antenna assemblies. The remote receivers can be a remote controller, a ground/docking station, a satellite, or the like. The propulsion system onboard the UAV is made up of propellors, motors, or the like, to fly the UAV. The flight control system is operatively coupled with the propulsion system to perform flight and navigation functions as directed by the remote receiver. Global Positioning System (GPS) information is captured by antenna assemblies over a wireless communication network established between remote satellites and the UAV and further relayed to a remote receiver over another wireless communication network established between the remote receiver and the UAV. Flight and navigation commands are provided to the remote receiver over the wireless communication network established between a remote receiver and the UAV.

The wireless communications are carried out within specific frequency range(s) based on the type of wireless communications. To transmit and receive signals to and from satellites, GPS antenna assemblies onboard the UAV include radiating elements that transmit and receive electromagnetic signals at specific frequencies. In particular, GPS antenna assemblies receive signals from orbiting satellites to determine the aerial vehicle's precise location, velocity, and time. The GPS antenna assemblies include a patch or helical antenna element, which is specifically designed to capture radio waves in the GPS frequency bands (L1, L2, L5).

Once the antenna element receives signals from satellite(s), a GPS receiver (often integrated into the same device as the antenna) processes these signals. This may entail analyzing the time it takes for the signals to travel from each satellite to the GPS antenna assembly using a technique called trilateration to determine the aerial vehicle's three-dimensional position (latitude, longitude, and altitude) on Earth at a given time. To calculate the aerial vehicle's distance from each satellite, the GPS receiver compares the time the signal was transmitted by the satellite to the time it was received by the GPS antenna element. The difference in time (known as the time delay) multiplied by the speed of light gives the distance to that satellite. By having distance measurements from a plurality of satellites (e.g., at least four satellites), the GPS receiver can determine the aerial vehicle's precise position in three-dimensional space by finding the intersection point (i.e., location) of spheres centered on each satellite.

Patch antennas are a type of directional antenna commonly used for wireless communication applications, including Wi-Fi, GPS, and satellite communication. They work based on the principles of electromagnetic wave propagation and resonance and rely on the fundamental properties of electromagnetic waves. These waves consist of electric and magnetic fields that oscillate in unison as they propagate through space. A patch antenna typically consists of a flat, conductive plate (interchangeably referring to the terms conductive plate, patch, and radiating element), which is often rectangular or square in shape. This conductive plate is mounted on a dielectric substrate to provide structural support and miniaturization. The other side of the dielectric substrate includes another metal plate which acts as a ground plane. These antennas are typically fed (i.e., coupled to a GPS receiver by a feed cable) via a microstrip line or thru-pin. The point where the feed connects influences the polarization and radiation characteristics of the antenna.

When the length and width of the patch, as well as the dielectric properties of the substrate, are designed as-intended, the patch antenna becomes resonant at a specific frequency or frequency range. The dimensions are typically a fraction of the wavelength of the intended operating frequency. Once the design for specific resonance is met, the antenna generates standing waves on its top surface (the radiating element) while the substrate supports the resonance modes along with the ground plane.

The size of the ground plane, or the ground plane dimensions, impacts the performance of a patch antenna as well. Patch antennas are typically designed with a ground plane beneath the radiating patch element. As mentioned earlier, the resonant frequency of a patch antenna is closely related to the dimensions of the patch and the ground plane. Increasing the size of the ground plane can impact the resonant frequency of the antenna. It also affects the shape and characteristics of the antenna's radiation pattern. In general, a larger ground plane helps maintain a more stable and consistent radiation pattern with a higher front-to-back ratio. Smaller ground planes may introduce additional lobes and distort the pattern. The directivity and gain of a patch antenna are related to its radiation pattern. A larger ground plane improves the antenna's gain and directivity, making it more suitable for directional applications such as GPS reception. Also, a well-sized ground plane is essential for the overall efficiency of the patch antenna as it may minimize losses and maximize the conversion of electrical energy into radiated energy.

In the context of UAVs, among other types of aerial vehicles, the enclosed space in which patch antennas are included onboard an aerial vehicle limits the dimensions of the patch antenna, and specifically, the dimensions of the ground plane. For example, the ground plane may be limited to specific footprint in at least one dimension, which may reduce the efficiency of the patch antenna and change the radiation pattern produced by the patch antenna. To maintain a minimum required surface area of the ground plane to ensure a high antenna gain, high efficiency, and a desired radiation pattern shape, described herein is an antenna assembly that includes an angled (referring to the terms angled, bent, folded, positioned at an angle interchangeably), curved, or otherwise concaved ground plane that maintains a similar gain profile and ground plane footprint as a flat ground plane unconstrained by space limitations. In an example embodiment, a middle portion of the ground plane remains in parallel and in the same plane as the radiating patch element above it, while side portions of the ground plane are angled or curved downwards to fit the contours of the aerial vehicle. In this way, the ground plane can fit the designed space while also ensuring all current phases stay aligned and do not fall below a threshold amount.

In an embodiment, an aerial vehicle is provided. The aerial vehicle comprises a body including a chassis and a frame affixed to the chassis, a plurality of rotor assemblies, a plurality of rotor arms, each rotor arm having a distal end, and a proximal end structurally coupled to the body and a rotor assembly of the plurality of rotor assemblies structurally coupled to the distal end, and an antenna assembly. The antenna assembly includes a radiating element positioned in parallel with the chassis, a substrate coupled to the radiating element, a ground plane coupled to the substrate, and a feed cable coupled to the radiating element through the substrate and the ground plane. The ground plane includes a center portion in parallel with the chassis and with the radiating element, and side portions positioned at an angle relative to the chassis and to the radiating element. It may be appreciated that other representations of the disclosed technology herein can include further systems, computing apparatuses, and methods of manufacturing or assembly elements of an aerial vehicle.

In another embodiment, an antenna assembly is provided. The antenna assembly includes a radiating element coupled to a chassis of an aerial vehicle and positioned in parallel with the chassis, a substrate coupled to the radiating element, a ground plane coupled to the substrate, and a feed cable coupled to the radiating element through the substrate and the ground plane. The ground plane includes a center portion in parallel with the chassis and with the radiating element, and side portions positioned at an angle relative to the chassis and to the radiating element.

In yet another embodiment, a method of manufacturing or assembling an antenna assembly is provided. The method includes affixing a radiating element of the antenna assembly to a circuit board, affixing a ground plane to a top layer of the circuit board, applying a substrate between the radiating element and the ground plane, and attaching a feed cable to the radiating element through a via of the circuit board. The ground plane includes a center portion in parallel with the radiating element, and side portions positioned at an angle relative to the radiating element.

Advantageously, the antenna assembly design described herein provide improvements to communications systems, devices, and protocols currently employed. For example, a ground plane of an antenna assembly can be shaped in several ways and at various angles and gradients to maintain a similar gain profile and radiation pattern as an antenna with a flat, or nearly flat, ground plane operating under similar conditions and at similar frequencies.

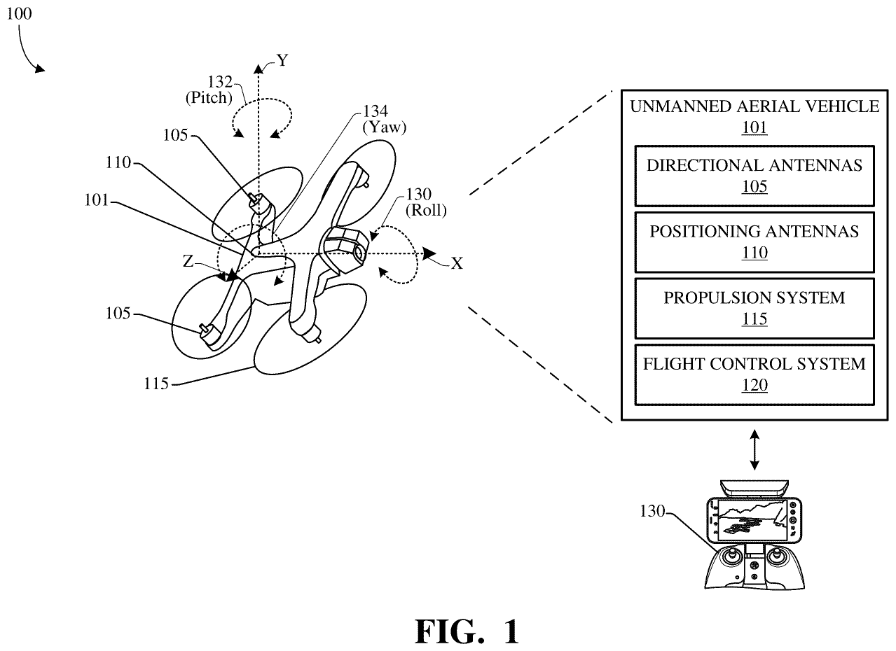

Turning now to the Figures, FIG. 1 illustrates an exemplary operating architecture 100 of an unmanned aerial vehicle (UAV) in which some embodiments of the present technology may be utilized. Operating architecture 100 includes UAV 101 and controller 130. UAV 101 is illustrated with respect to rotation terminology references including roll 130 which indicates a degree of rotation about the x-axis, pitch 132, which indicates a degree of rotation about the y-axis, and yaw 134, which indicates a degree of rotation about the z-axis.

As illustrated in operating architecture 100, UAV 101 comprises a body or frame, multiple directional antennas 105, one or more positioning antennas 110, a propulsion system 115, and a flight control system 120 directed to communicate with controller 130 via the directional antennas 105. In various embodiments, the body of UAV 101 includes a chassis internal to the body of UAV 101 that provides support for the body and for the various components of UAV 101. For example, directional antennas 105, positioning antennas 110, propulsion system 115, and flight control system 120 are affixed to portions of the chassis and/or to portions of the body.

Flight control system 120 is representative of a processing system that provides flight control, navigation, data collection, and other capabilities for UAV 101. In various embodiments, flight control system 120 includes one or more processors configured to enable such functionality via hardware, software, and firmware, as well as combinations and variations thereof. Examples of the processors of flight control system 120 includes one or more of central processing units (CPUs), graphical processing units (GPUs), general purpose processors, field-programmable logic arrays (FPGAs), application-specific integrated circuits (ASICs), digital signal processors (DSPs), and the like.

Flight control system 120 operates in remote communication with systems and devices via directional antennas 105 and via positioning antennas 110. For example, flight control system 120 communicates with controller 130 via directional antennas 105, and flight control system 120 communicates with satellites or other Global Positioning System (GPS) devices via positioning antennas 110. In some implementations, controller 130 includes a mobile phone, tablet, or other computer running software configured to communicate with and control UAV 101. In other embodiments, controller 130 can be a stationary ground station or docking station comprising multiple antennas used to communicate with UAV 101.

In a receive mode during GPS tracking operations, flight control system 120 receives signals from one or more satellites orbiting Earth via positioning antennas 110. These signals may include position, location, and time information (e.g., Global Positioning System (GPS) data) related to UAV 101 for use in triangulating a position of UAV 101 at a given time. In a transmit mode during GPS tracking operations, flight control system 120 transmits signals related to the GPS information to controller 130 via directional antennas 105. In transmit and receive modes during other operational modes, flight control system 120 transmits other information to controller 130, such as images, videos, and other sensor data, and receives commands and controls for maneuvering propulsion system 115 of UAV 101 and capturing such data, respectively.

Propulsion system 115 is representative of a system that provides flight capabilities of UAV 101. In various embodiments, propulsion system 115 includes propellors, motors, a propeller control system, rotor assemblies, rotor arms and the like. The rotor arms extend from the body of UAV 101 and include rotor assemblies and propellors affixed to top or bottom portions of the rotor arms. More specifically, each rotor arm includes a proximal end structurally coupled to the body of UAV 101, and a distal end extending away from the body to which a rotor assembly is structurally coupled.

In various embodiments, directional antennas 105 are also coupled to the rotor arms of propulsion system 115. In some embodiments, directional antennas 105 include four antenna assemblies, and each antenna assembly may be coupled to one of four rotor arms of UAV 101 either internally to the body of UAV, external to the body of UAV 101, or some combination thereof. Each antenna assembly includes a radiating element capable of producing energy to transmit signals (e.g., data) to controller 130 and receive signals (e.g., commands, controls) from controller 130, respectively. Each antenna assembly also includes a feed cable coupling the radiating element to flight control system 120. The feed cables of the antenna assemblies are utilized to provide received signals from controller 130 to flight control system 120, and to provide signals from flight control system 120 to be transmitted by the radiating element to controller 130.

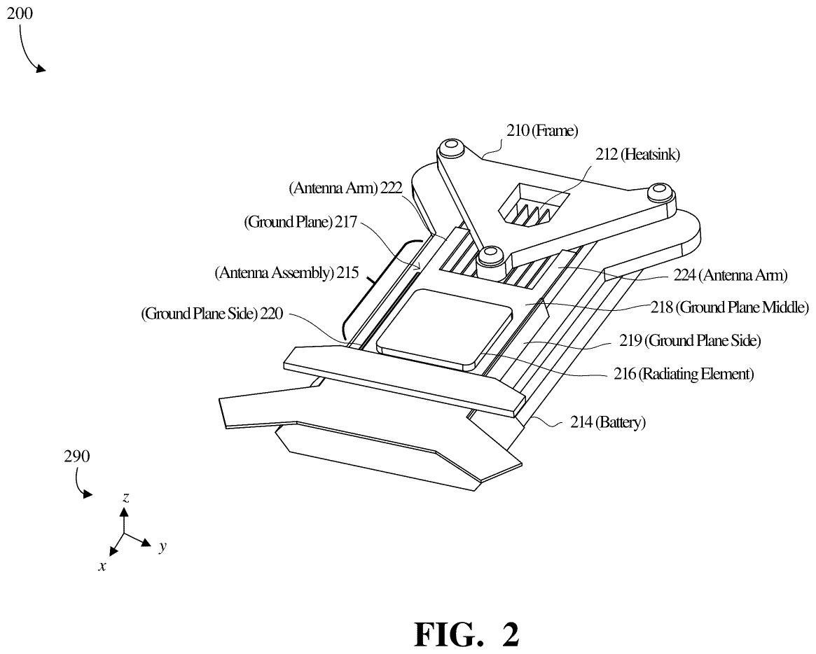

In various embodiments, positioning antennas 110 are coupled to the body or a chassis of UAV 101. Positioning antennas 110 may include one or more patch antenna assemblies, helical antenna assemblies, or other types of antennas, as well as combinations and variations thereof capable of communicating with satellites and other GPS systems or devices. Positioning antennas 110 also include feed cables coupling antenna elements of the antenna assemblies to flight control system 120. As such, positioning antennas 110 can provide signals to flight control system 120 via the feed cables and receive signals from flight control system 120 to be transmitted to GPS systems and/or controller 130. Examples of positioning antennas 110, the elements thereof, and the placement thereof onboard UAV 101 are shown below in FIGS. 2, 3, and 5.

FIG. 2 illustrates an exemplary operating architecture of an unmanned aerial vehicle in which some embodiments of the present technology may be utilized. FIG. 2 includes an isometric view of a UAV, such as UAV 101 of FIG. 1, showing operating architecture 200 which includes elements internal to the UAV. More specifically, operating architecture 200 includes frame 210, heatsink 212, battery 214, and antenna assembly 215. Antenna assembly 215 includes radiating element 216, ground plane 217, and antenna arms 222 and 224. The following description of the elements of operating architecture 200 are discussed with respect to axes 290.

Frame 210 is representative of a chassis of a UAV to which various components are affixed. For example, frame 210 includes an aluminum chassis elongated across the x-axis with some components affixed to frame 210 at a proximal end (e.g., in the +x direction, also referred to as the forward direction), some components affixed at a distal end (e.g., in the −x direction, also referred to as the rear or reverse direction), some components affixed on top (e.g., in the +z direction), some components affixed on the bottom (e.g., in the −z direction), some components affixed on a left side (e.g., in the +y direction), and some components affixed on a ride side (e.g., in the −y direction). In particular, battery 214 is coupled to the bottom of frame 210, heatsink 212 is coupled to frame 210 and to battery 214 above battery 214, and antenna assembly 215 is coupled to heatsink 214 and to the top of frame 210.

Antenna assembly 215 includes various components that, in operation, produce electromagnetic waves with which antenna assembly 215 transmits and receives signals to and from other devices, respectively. In various embodiments, antenna assembly 215 is representative of a patch or helical antenna used in wireless communications applications, such as in GPS applications, operating in one or more frequency ranges. Additionally, in some embodiments, antenna assembly 215 is representative of an inverted-F antenna (IFA) used in other wireless communications applications, or at least, operating in different frequency ranges relative to the patch or helical antenna.

In various embodiments, antenna assembly 215 includes a circuit board (e.g., a printed circuit board (PCB)), and a radiating element 216, a ground plane 217, a substrate between radiating element 216 and ground plane 217, a feed cable affixed to the circuit board and to a processing system onboard the UAV (e.g., flight control system 120 of UAV 101), and antenna arms 222 and 224.

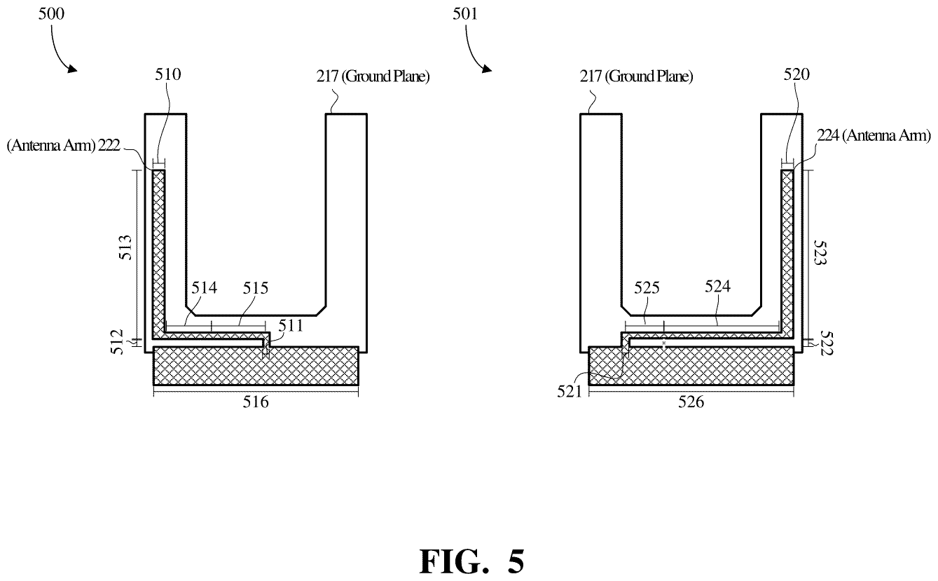

The circuit board of antenna assembly 215 includes various layers, electrical traces, vias, and dielectric materials (e.g., FR4), among other elements with which the radiating element, substrate, ground plane, and feed cable are coupled to one or more of each other. In particular, radiating element 216 includes a conductive plate (e.g., a patch) affixed to a top layer of the circuit board. The substrate includes one or more dielectric materials affixed to a layer of the circuit board and affixed to the bottom of radiating element 216. The ground plane 217 includes another conductive plate affixed to a layer of the circuit board and affixed to a side of substrate opposite radiating element 216. Antenna arms 222 and 224 include conductive plates extending from ground plane 217 in the −x direction that form an IFA. In various embodiments, antenna arms 222 and 224 are affixed to different layers of the circuit board relative to one another, such as on a bottom layer of the circuit board, and on a top layer of the circuit board, respectively. An example aspect of antenna arms 222 and 224 is shown and described below with respect to FIG. 5.

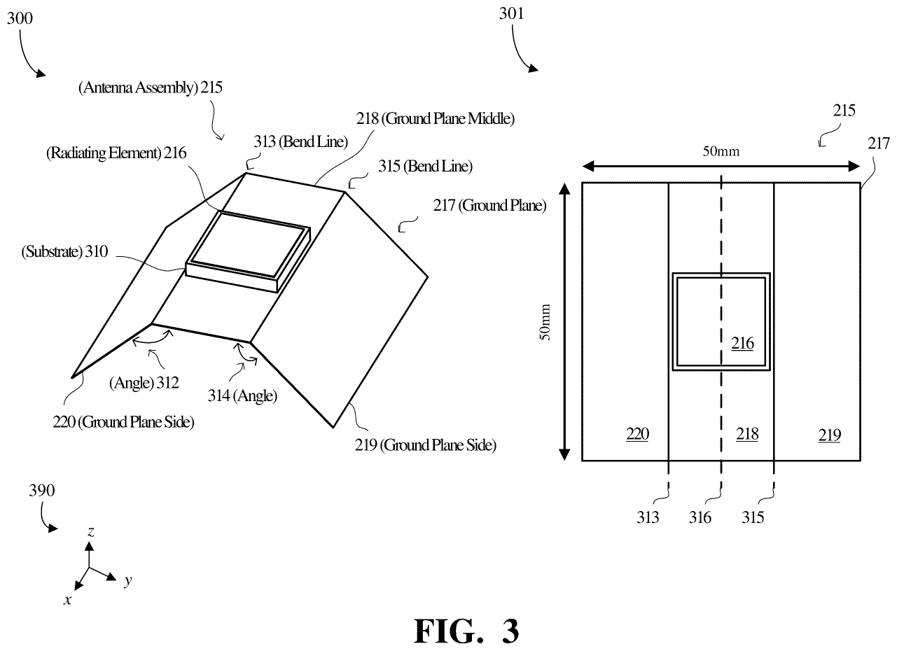

As shown in operating architecture 200, frame 210 is shaped such that frame 210 has a greater length (in the x-direction) than width (in the y-direction). Accordingly, antenna assembly 215, and in particular, ground plane 217, is more limited in width than in length and is shaped to fit the contours of frame 210. In order to retain a width and a surface area as if ground plane 217 were not limited in y-direction, portions of ground plane 217 are angled or curved downwards (e.g., in the −z direction) (referring to the terms angled, slanted, bent, folded, positioned at an angle interchangeably). Ground plane 217 includes a middle portion (ground plane middle 218) in parallel with, and in a plane beneath, radiating element 216. Ground plane 217 includes a first side portion (ground plane side 219) angled downwards on the left side of frame 210 to fit a side contour of frame 210. Ground plane 217 also includes a second side portion (ground plane side 220) angled downwards on the right side of frame 210 to fit another side contour of frame 210. In various embodiments, ground plane sides 219 and 220 are wider (e.g., with respect to the y-axis) than ground plane middle 218, such that to radiating element 216, ground plane 217 appears and functions like a flat ground plane having the same effective dimensions as ground plane 217. As a result of the shaping of ground plane 217 and the dimensions of ground plane 217, antenna assembly 215 may produce electromagnetic waves having a similar radiation pattern, gain, and efficiency as a patch antenna having a flat, or nearly flat, ground plane. Additional details of antenna assembly 215 are shown and described below in FIGS. 3-8.

Moving to FIG. 3, FIG. 3 illustrates aspects of antenna assembly 215 in which some embodiments of the present technology may be utilized. FIG. 3 includes aspects 300 and 301, both of which show views of antenna assembly 215 and elements thereof. The following description of antenna assembly 215 is discussed with respect to axes 390.

Referring first to aspect 300, aspect 300 shows an isometric view of antenna assembly 215 that includes radiating element 216, substrate 310, and ground plane 217. Radiating element 216 is positioned in a first plane, ground plane 217 is positioned below radiating element 216 (e.g., with respect to the z-axis), and substrate 310 (e.g., a dielectric material) is affixed to both radiating element 216 and ground plane middle 218 (i.e., a middle portion of ground plane 217) and positioned in parallel with radiating element 216 in a second plane.

Ground plane side 220 is angled (referring to the terms angled, slanted, bent, folded, positioned at an angle interchangeably) downwards (e.g., in the −z direction) from ground plane middle 218 by angle 312, while ground plane side 219 is angled downwards (e.g., in the −z direction) from ground plane middle 218 by angle 314. In various embodiments, ground plane sides 219 and 220 are physically folded along edges of ground plane middle 218, such as at bend lines 315 and 313, respectively.

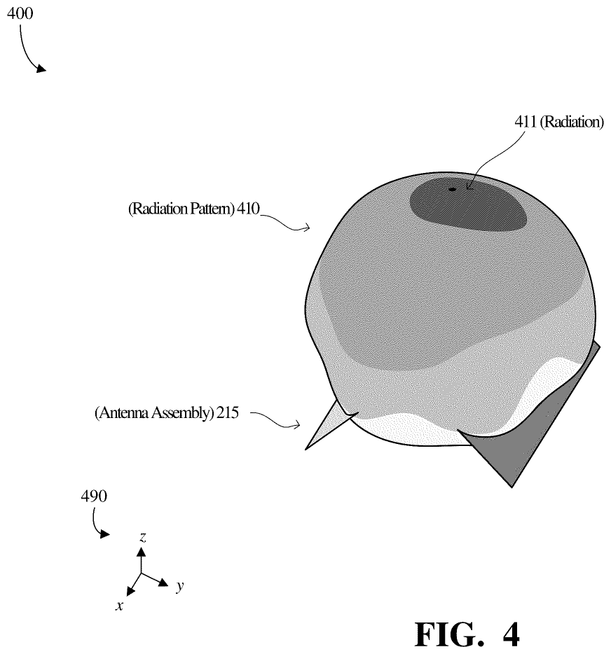

In various embodiments, angles 312 and 314 are the same, however, the angles may be different from each other in some embodiments. Angles 312 and 314 are selected based on one or more factors, such as the dimensions of radiating element 216, the dimensions of ground plane 217, and a desired operating frequency, gain, and radiation pattern of antenna assembly 215. An example radiation pattern of antenna assembly 215 is shown in FIG. 4.

In various embodiments, angles 312 and 314 include an angle between five degrees and sixty degrees. By way of another example, angles 312 and 314 include an angle between five degrees and forty-five degrees. Other threshold ranges of angles may be contemplated. In particular, angles 312 and 314 may be selected to avoid reducing current phases beyond a threshold amount (e.g., 70%), to prevent the in-phase currents and voltages from reducing by another threshold amount (e.g., 50%), and/or to prevent the overall gain of antenna assembly by a threshold gain amount (e.g., 3 dB). Additionally, or instead, angles 312 and 314 may include several angles such that ground plane sides 219 and 220 are curved or concaved downward (e.g., have a gradient slope downward).

Referring next to aspect 301, aspect 301 shows a top-down view of antenna assembly 215. In various embodiments, radiating element 216 includes a square-shaped conductive plate having a first set of dimensions (length, width, height) for conforming to a device (i.e., an external device, e.g., UAV 101). Ground plane 217 includes a conductive plate made up of three rectangular-shaped portions each having their own set of dimensions to fit a specific contour of the device. More specifically, ground plane 217 includes ground plane middle 218, ground plane side 219, and ground plane side 220.

Ground plane middle 218 is representative of a center portion of ground plane 217 formed in a first plane. Ground plane side 219 is representative of a first side portion extending from a first edge (bend line 315) of ground plane middle 218. Ground plane side 219 is oriented in a second plane at angle 314 relative to the first plane in which ground plane middle 218 resides. Bend line 315, the edge of ground plane middle 218 at which ground plane side 219 is bent, is positioned at a first contour of the device. Ground plane 220 is representative of a second side portion extending from a second edge (bend line 313) of ground plane middle 218. Ground plane side 220 is oriented in a third plane at angle 312 relative to the first plane. Bend line 313 is positioned at a second contour of the device. In various embodiments, the second and third planes are symmetrical about center axis 316 passing through a midpoint of ground plane middle 218. In this configuration, ground plane middle 218, ground plane side 219, and ground plane side 220 form three distinct planes that collectively conform to the contours of the device to which ground plane 217 is affixed.

Ground plane middle 218 includes a second set of dimensions, ground plane side 219 includes a third set of dimensions, and ground plane side 220 includes a fourth set of dimensions. In various embodiments, the dimensions of ground plane sides 219 and 220 are the same. In various embodiments, the lengths (e.g., with respect to the x-axis) of ground plane middle 218, ground plane side 219, and ground plane side 220 are the same, the widths (e.g., with respect to the y-axis) of ground plane sides 219 and 220 are the same, and such widths are greater than the width of ground plane middle 218.

As shown in aspect 301, from the perspective of radiating element 216, ground plane 217 appears as a square-shaped conductive plate being 50 millimeters wide and 50 millimeters long despite having a greater width (e.g., with respect to the y-axis) than length (e.g., with respect to the x-axis). Thus, ground plane 217, from the perspective of radiating element 216, has approximately the same footprint as a flat or nearly-flat ground plane. In effect, antenna assembly 215 is capable of producing the same gain profile as a flat or nearly-flat antenna assembly while maintaining a smaller overall width (e.g., with respect to the y-axis) to fit into space-limited areas.

FIG. 4 illustrates graphical representation 400, which shows radiation pattern 410 produced by an antenna assembly having a ground plane with slanted or curved side portions to fit into space-limited areas in which some embodiments of the present technology may be utilized. For example, radiation pattern 410 may be produced by antenna assembly 215, representative of one of positioning antennas 110 of UAV 101 of FIG. 1. The following description of graphical representation and antenna assembly 215 is discussed with respect to axes 490.

As shown in graphical representation 400, radiation pattern 410 includes a near-spherical shape illustrative of energy produced by antenna assembly 215. The strength of the energy is depicted as strongest to weakest by darkest color to lightest color. For example, radiation 411 is representative of the greatest amount of radiation produced by antenna assembly 215, which is the energy at the top of radiation pattern with respect to the z-axis. In various applications, radiation pattern 410 may be an ideal pattern as radiation 411 is targeted in a single direction resulting in a desired gain in a target direction.

Contrarily, for an antenna assembly with a ground plane reduced to a single dimension, such as a ground plane extending a length in the +x and −x directions and without slanted or curved ground plane portions extending in the ty and −y directions (i.e., a ground plane having ground plane middle 218 but not ground plane sides 219 and 220), the radiation pattern may be expanded in the +y and −y directions and squeezed in the +x and −x directions resulting in an suboptimal gain profile for various wireless communications applications.

FIG. 5 illustrates aspects of an antenna assembly of an unmanned aerial vehicle in which some embodiments of the present technology may be utilized. FIG. 5 includes aspects 500 and 501, which show top-down views of ground plane 217 of antenna assembly 215.

In particular, aspects 500 and 501 show antenna arms 222 and 224, respectively, which form a dual-band inverted-F antenna (IFA) on ground plane 217. Accordingly, antenna assembly 215 includes both a patch or helical antenna operating in conjunction with a dual-band IFA. In various embodiments, the IFA provides advantageous characteristics in wireless communications applications. The planar structure of the IFA facilitates a low-profile design, a highly desirable attribute for electronic devices wherein a slim and aesthetically pleasing form is sought. The integration of IFA into a circuit board also including a patch antenna for other wireless communication purposes (antenna assembly 215) serves to streamline the manufacturing process and reduces production costs.

Additionally, the IFA possesses the capability for multiband operation, allowing antenna assembly 215 to operate across multiple frequency bands concurrently. This intrinsic flexibility allows antenna assembly 215 to operate in accordance with several diverse wireless communication standards like WLAN, Bluetooth, GPS, and cellular networks. In various embodiments, the IFA of antenna assembly 215 is designed (e.g., based on various dimensions of antenna arms 222 and 224, based on placement of antenna arms 222 and 224 relative to one another, to ground plane 217, and to radiating element 216, among other factors) to operate at the 980 and 1090 MHz frequency bands, catering specifically to aeronautical applications and to radio navigation applications. However, other frequency bands and applications may be contemplated. With this design of the IFA of antenna assembly 215, the IFA may be capable of operating with a radiation efficiency exceeding 95% and with a gain surpassing 4 dBi.

The excitation point of the IFA may be connected to a chip output pin of the circuit board on which ground plane 217, antenna arm 222, and antenna arm 224, among other elements, are coupled through a 50 Ohms coplanar waveguide (CPW). More particularly, the IFA may be coupled to other elements of the circuit board, and to other elements of an aerial vehicle on which the IFA is affixed (e.g., UAV 101) through various electrical traces, vias, and the like. The inclusion of antenna arms 222 and 224 extending from ground plane 217 may serve the purpose of at least adjusting the resonant frequency of the IFA of antenna assembly 215 to align with the specified frequency bands. Accordingly, when coupled to a processor onboard the aerial vehicle on which the IFA is affixed (e.g., flight control system 120 of UAV 101), the processor receives signals from the IFA in the specified frequency bands.

Referring now to aspect 500, aspect 500 shows a portion of ground plane 217 on which antenna arm 222 is affixed. Antenna arm 222 is representative of a first radiating element of the dual-band IFA. Antenna arm 222 is affixed to a first arm of ground plane 217 extending from a distal end of ground plane 217 (with respect to operating architecture 200 of FIG. 2). In various embodiments, antenna arm 222 is affixed to a top layer of ground plane 217, or to a top layer of a circuit board on which ground plane 217 is also affixed.

In various embodiments, as mentioned above, the dimensions of antenna arm 222 are selected based on desired operating characteristics of the IFA. For example, the dimensions of antenna arm 222 are selected based on a desired first operating frequency of the IFA (e.g., 1090 MHz). These dimensions include width 510, width 511, height 512, length 513, length 514, length 515, length 516. In some embodiments, width 510 is 2 millimeter (mm), width 511 is 1 mm, height 512 is 1 mm, length 513 is 44 mm, length 514 is 12.5 mm, length 515 is 8 mm, and length 516 is 41 mm. Other dimensions may be contemplated.

Referring next to aspect 501, aspect 501 shows a portion of ground plane 217 on which antenna arm 224 is affixed. Antenna arm 224 is representative of a second radiating element of the dual-band IFA. Antenna arm 224 is affixed to a second arm of ground plane 217 extending from a distal end of ground plane 217 (with respect to operating architecture 200 of FIG. 2). In various embodiments, antenna arm 222 is affixed to a bottom layer (or a lower layer relative to the layer on which antenna arm 224 is affixed) of ground plane 217, or to a bottom layer of the circuit board on which ground plane 217 is also affixed.

In various embodiments, as mentioned above, the dimensions of antenna arm 224 are selected based on desired operating characteristics of the IFA. For example, the dimensions of antenna arm 224 are selected based on a desired first operating frequency of the IFA (e.g., 980 MHz). These dimensions include width 520, width 521, height 522, length 523, length 524, length 525, length 526. In some embodiments, width 520 is 2 mm, width 521 is 1 mm, height 522 is 1 mm, length 523 is 43 mm, length 524 is 24 mm, length 525 is 8 mm, and length 526 is 41 mm. Other dimensions may be contemplated.

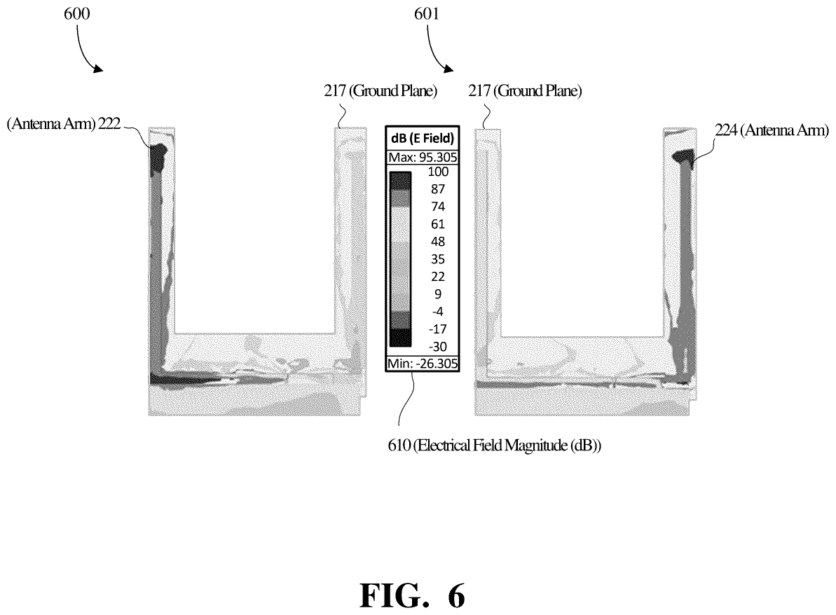

FIG. 6 illustrates example electrical field patterns produced by an antenna assembly of an unmanned aerial vehicle in which some embodiments of the present technology may be utilized. In particular, FIG. 6 includes graphical representations 600 and 601, which include example electrical field patterns produced by antenna arms 222 and 224, respectively, of antenna assembly 215 with respect to electrical field magnitude 610.

In graphical representation 600, it can be seen that antenna arm 222 produces the highest magnitude electrical field at the distal end of the arm extension of ground plane 217. In various embodiments, this electrical field produced by antenna arm 222 represents a pattern produced at a first operating frequency of 1090 MHz.

Similarly, in graphical representation 601, it can be seen that antenna arm 224 produces the highest magnitude electrical field at the distal end of the arm extension of ground plane 217. In various embodiments, this electrical field produced by antenna arm 224 represents a pattern produced at a second operating frequency of 980 MHz.

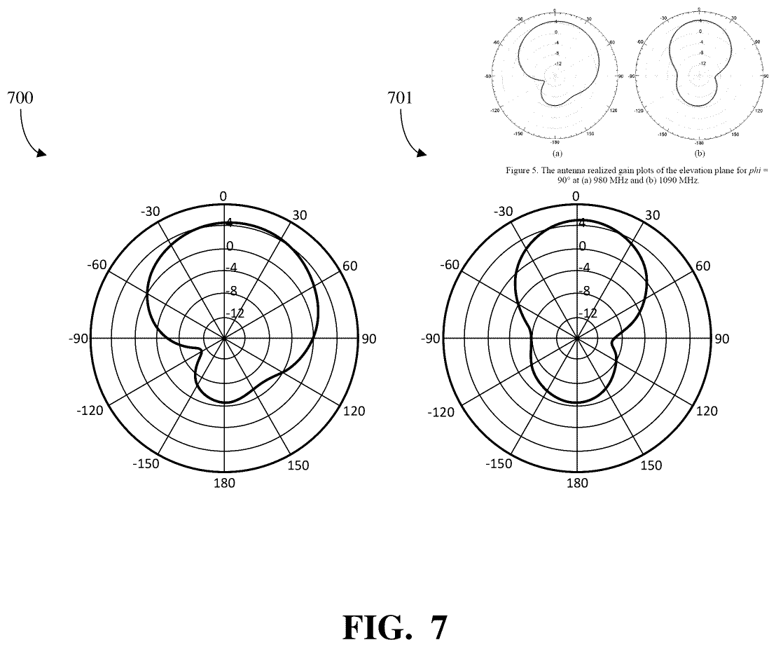

FIG. 7 illustrates example antenna gain patterns produced by an antenna assembly of an unmanned aerial vehicle in which some embodiments of the present technology may be utilized. In particular, FIG. 7 includes graphical representations 700 and 701, which include example gain plots of an elevation field at different operating frequencies produced by antenna arms 222 and 224, respectively, of antenna assembly 215.

In various embodiments, the gain plots shown in graphical representations 700 and 701 are representative of realized antenna gain from the IFA formed by antenna arms 222 and 224, respectively, for an elevation plane when the phi angle is equal to 90 degrees. More specifically, graphical representation 700 includes such a gain plot realized at a first operational frequency of 980 MHz, while graphical representation 701 includes such a gain plot realized at a second operational frequency of 1090 MHz.

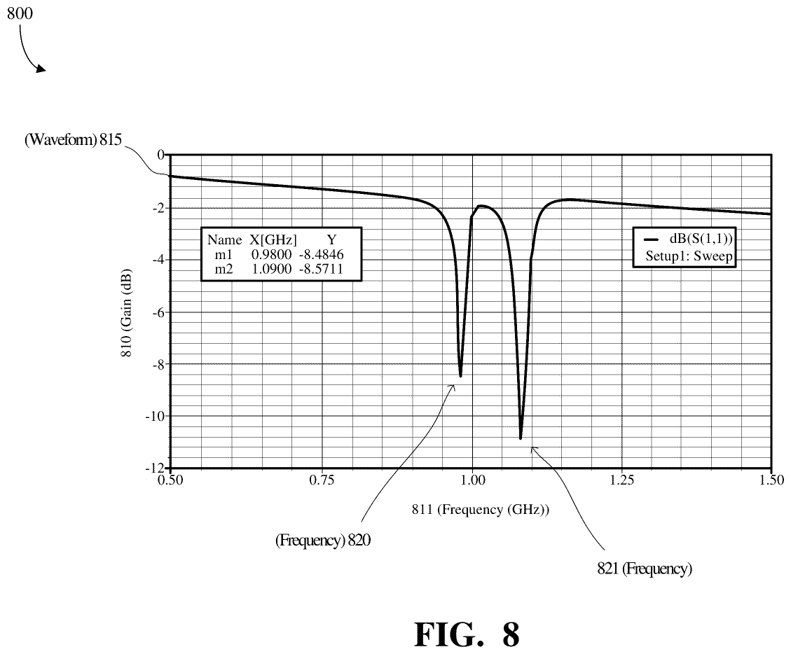

FIG. 8 illustrates an example waveform related to antenna gain and frequency of an antenna assembly of an unmanned aerial vehicle in which some embodiments of the present technology may be utilized. FIG. 8 illustrates graphical representation 800, which includes waveform 815 produced by a dual-band inverted-F antenna (IFA) of antenna assembly 215 formed by antenna arms 222 and 224. In particular, waveform 815 shows antenna gain 810 with respect to frequency 811.

Waveform 815 shows that gain 810 remains below-8 dB at both frequency 820 (980 MHz) and at frequency 821 (1090 MHz). Due to the intricate nature of the electromagnetic environment surrounding antenna assembly 215, attaining a stable 50 Ohms input impedance through exclusive adjustments to the antenna's physical dimensions presents challenges. Thus, the dimensions and shape of antenna arms 222 and 224 (e.g., such as dimensions shown in FIG. 5) are chosen to form an L-shaped matching circuit, which may reduce gain 810 to levels below-15 dB across both frequency 820 and frequency 821.

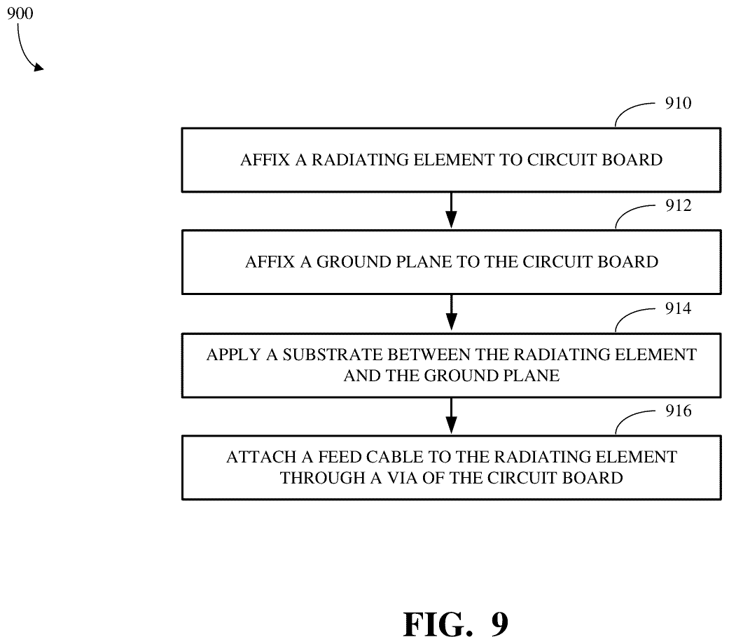

FIG. 9 is a flowchart illustrating an exemplary process for manufacturing or assembly an antenna assembly in accordance with some embodiments of the present technology. FIG. 9 includes method 900 which includes various steps to assembly elements of an antenna assembly and affix the antenna assembly to an aerial vehicle. For example, method 900 can be implemented to assemble antenna assembly 215 of UAV 101.

Method 900 includes affixing (910) (e.g., attaching, coupling, soldering, or otherwise physically and/or electrically coupling) a radiating element to a circuit board. The radiating element of the antenna assembly is representative of a conductive plate capable of converting electrical energy into electromagnetic waves for transmission and reception of signals at specific operating frequencies. The radiating element may be affixed to a layer of the circuit board (e.g., a PCB). The circuit board may include various other electrical and conductive elements, traces, vias, and the like.

Method 900 also includes affixing (912) a ground plane to the circuit board. More particularly, step 912 includes affixing the ground plane below the radiating element such that the radiating element is above and in parallel, at least in one plane, with a portion of the ground plane to form a patch or helical antenna. The ground plane includes a middle portion in parallel with the radiating element, and two side portions (not overlapped by the radiating element) that are bent, angled, slanted, or curved downwards to limit the ground plane's footprint in at least one axis. An example of the shape of the ground plane and the positioning relative to the radiating element is shown in FIG. 3 above (e.g., ground plane 217).

Method 900 also includes applying (914) a substrate between the radiating element and the ground plane, thus physically separating the radiating element and the ground plane. In various embodiments, the substrate includes a dielectric material having dimensions (length, width, thickness) to, at least partially, effectuate a desired radiation pattern of the antenna assembly during operation when the radiating element and ground plane produce electromagnetic waves.

Method 900 further includes attaching (916) a feed cable to the radiating element. In various embodiments, the feed cable is representative of a conductive cable for transferring signals to the radiating element for transmission thereof and for receiving signals from the radiating element for use by a processing system (e.g., flight control system 120 of FIG. 1). The feed cable may be affixed to the circuit board, such as by soldering the feed cable to a solder point on the circuit board. Then, the feed cable may be electrically coupled to the radiating element through one or more electrical traces and vias of the circuit board.

Disclosed herein are implementations of antenna selection using an unmanned aerial vehicle.

In a first aspect, the subject matter described in this specification can be embodied in systems that include an aerial vehicle comprising: a body including a chassis and a frame affixed to the chassis, a plurality of rotor assemblies, a plurality of rotor arms, each rotor having a distal end, and a proximal end structurally coupled to the body and a rotor assembly of the plurality of rotor assemblies structurally coupled to the distal end, and an antenna assembly comprising: a radiating element positioned in parallel with the chassis, a substrate coupled to the radiating element, a ground plane coupled to the substrate, and a feed cable coupled to the radiating element through the substrate and the ground plane, wherein the ground plane includes a center portion in parallel with the chassis and with the radiating element, and side portions positioned at an angle relative to the chassis and to the radiating element.

In a second aspect, the subject matter described in this specification can be embodied in systems that include the aerial vehicle of the preceding aspect, wherein the center portion of the ground plane is positioned axially in a different plane relative to the radiating element.

In a third aspect, the subject matter described in this specification can be embodied in systems that include the aerial vehicle of the preceding aspect(s), wherein the radiating element overlaps a middle portion of the center portion of the ground plane, and wherein the center portion of the ground plane extends a length and a width greater than the radiating element.

In a fourth aspect, the subject matter described in this specification can be embodied in systems that include the aerial vehicle of the preceding aspect(s), wherein a width of the side portions of the ground plane is greater than a width of the center portion of the ground plane.

In a fifth aspect, the subject matter described in this specification can be embodied in systems that include the aerial vehicle of the preceding aspect(s), wherein, based on the angle of the side portions, the antenna assembly creates a signal having shaped radiation in a desired direction.

In a sixth aspect, the subject matter described in this specification can be embodied in systems that include the aerial vehicle of the preceding aspect(s), wherein the angle of the side portions includes a threshold angle between five degrees and sixty degrees.

In a seventh aspect, the subject matter described in this specification can be embodied in systems that include the aerial vehicle of the preceding aspect(s), wherein the angle of the side portions includes a threshold angle between five degrees and forty-five degrees.

In an eighth aspect, the subject matter described in this specification can be embodied in systems that include the aerial vehicle of the preceding aspect(s), wherein the side portions comprise concaved-shaped portions, and wherein the angle comprises multiple angles forming a concave shape.

In a ninth aspect, the subject matter described in this specification can be embodied in systems that include the aerial vehicle of the preceding aspect(s) and further comprising a processor coupled to the antenna assembly via the cable feed, wherein the processor is configured to receive a signal from the antenna assembly having shaped radiation in a desired direction based on the angle of the side portions.

In a tenth aspect, the subject matter described in this specification can be embodied in systems that include the aerial vehicle of the preceding aspect(s), wherein the radiating element comprises a patch antenna element or a helical antenna element, and wherein the signal comprises a signal in a Global Positioning System frequency band.

In an eleventh aspect, the subject matter described in this specification can be embodied in systems that include the aerial vehicle of the preceding aspect(s), wherein: the antenna assembly further comprises a circuit board having multiple layers, a proximal end, a distal end, a right side, and a left side; the center portion of the ground plane is positioned on a top layer of the circuit board of the antenna assembly; a first side portion of the side portions extends from the left side on the top layer of the circuit board; and a second side portion of the side portions extends from the right side on the top layer of the circuit board.

In a twelfth aspect, the subject matter described in this specification can be embodied in systems that include the aerial vehicle of the preceding aspect(s), wherein the circuit board includes two conductive arms extending a distance in parallel with the center portion of the ground plane, wherein a first conductive arm of the two conductive arms is positioned on the top layer of the circuit board and a second conductive arm of the two conductive arms is positioned on a lower layer of the circuit board relative to the top layer of the circuit board.

In a thirteenth aspect, the subject matter described in this specification can be embodied in systems that include the aerial vehicle of the preceding aspect(s), wherein a combination of the radiating element and the ground plane form a patch antenna, and wherein a combination of the ground plane and the two conductive arms form an inverted-F antenna.

In a fourteenth aspect, the subject matter described in this specification can be embodied in systems that include the aerial vehicle of the preceding aspect(s), further comprising a processor coupled to the antenna assembly via the cable feed, wherein the processor is configured to receive a first signal from the first conductive arm in a first frequency band and a second signal from the second conductive arm in a second frequency band.

In a fifteenth aspect, the subject matter described in this specification can be embodied in systems that include the aerial vehicle of the preceding aspect(s), wherein the first frequency band includes a 980 MHz frequency band, and wherein the second frequency band includes a 1090 MHz frequency band.

In a sixteenth aspect, the subject matter described in this specification can be embodied in systems that include the aerial vehicle of the preceding aspect(s), wherein dimensions of the first and second conductive arms are selected based on the first and second frequency bands and based on a target impedance.

In a seventeenth aspect, the subject matter described in this specification can be embodied in systems that include an antenna assembly comprising: a radiating element coupled to a chassis of an aerial vehicle and positioned in parallel with the chassis, a substrate coupled to the radiating element, a ground plane coupled to the substrate, and a feed cable coupled to the radiating element through the substrate and the ground plane, wherein the ground plane includes a center portion in parallel with the chassis and with the radiating element, and side portions positioned at an angle relative to the chassis and to the radiating element.

In an eighteenth aspect, the subject matter described in this specification can be embodied in systems that include the antenna assembly of the preceding aspect, wherein: the center portion of the ground plane is positioned axially in a different plane relative to the radiating element; the radiating element overlaps a middle portion of the center portion of the ground plane; the center portion of the ground plane extends a length and a width greater than the radiating element; and a width of the side portions of the ground plane is greater than a width of the center portion of the ground plane.

In a nineteenth aspect, the subject matter described in this specification can be embodied in systems that include the antenna assembly of the preceding aspect(s), wherein, based on the angle of the side portions, the antenna assembly creates a signal having shaped radiation in a desired direction, wherein the angle of the side portions is greater than five degrees and less than sixty degrees.

In a twentieth aspect, the subject matter described in this specification can be embodied in systems that include the antenna assembly of the preceding aspect(s), further comprising a circuit board having multiple layers, a proximal end, a distal end, a right side, and a left side, wherein: the center portion of the ground plane is positioned on a top layer of the circuit board of the antenna assembly; a first side portion of the side portions extends from the left side on the top layer of the circuit board; and a second side portion of the side portions extends from the right side on the top layer of the circuit board.

In a twenty-first aspect, the subject matter described in this specification can be embodied in systems that include the antenna assembly of the preceding aspect(s), wherein: the circuit board includes two conductive arms extending a distance in parallel with the center portion of the ground plane; a first conductive arm of the two conductive arms is positioned on the top layer of the circuit board; a second conductive arm of the two conductive arms is positioned on a lower layer of the circuit board relative to the top layer of the circuit board; and each of the two conductive arms operates in a frequency band different relative to one another and different relative to the radiating element of the antenna assembly.

In a twenty-second aspect, the subject matter described in this specification can be embodied in methods of manufacturing or assembling of an antenna assembly comprising: affixing a radiating element of the antenna assembly to a circuit board, affixing a ground plane to a top layer of the circuit board, applying a substrate between the radiating element and the ground plane, and attaching a feed cable to the radiating element through a via of the circuit board, wherein the ground plane includes a center portion in parallel with the radiating element, and side portions positioned at an angle relative to the radiating element.

In a twenty-third aspect, the subject matter described in this specification can be embodied in a ground plane for an antenna configured to conform to an external device, the ground plane comprising: a center portion formed in a first plane, a first side portion extending from a first edge of the center portion and oriented in a second plane at a first angle relative to the first plane, wherein a first fold line between the center portion and the first side portion is positioned along a first contour of the external device, a second side portion extending from a second edge of the center portion, opposite the first edge, and oriented in a third plane at a second angle relative to the first plane, wherein a second fold line between the center portion and the second side portion is positioned along a second contour of the external device, wherein the second plane and the third plane are symmetrical about a central axis passing through the center portion, and wherein the center portion, the first side portion, and the second side portion together define three distinct planes that collectively conform to the contours of the external device.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for,” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

What is claimed is:

1. An aerial vehicle comprising:
a body including a chassis and a frame affixed to the chassis;
a plurality of rotor assemblies;
a plurality of rotor arms, each rotor arm having a distal end, and a proximal end structurally coupled to the body and a rotor assembly of the plurality of rotor assemblies structurally coupled to the distal end;
an antenna assembly comprising:
a radiating element positioned in parallel with the chassis;
a substrate coupled to the radiating element;
a ground plane coupled to the substrate; and
a feed cable coupled to the radiating element through the substrate and the ground plane;
wherein the ground plane includes a center portion in parallel with the chassis and with the radiating element, and side portions positioned at an angle relative to the chassis and to the radiating element.

2. The aerial vehicle of claim 1, wherein the center portion of the ground plane is positioned axially in a different plane relative to the radiating element.

3. The aerial vehicle of claim 1, wherein the radiating element overlaps a middle portion of the center portion of the ground plane, and wherein the center portion of the ground plane extends a length and a width greater than the radiating element.

4. The aerial vehicle of claim 3, wherein a width of the side portions of the ground plane is greater than a width of the center portion of the ground plane.

5. The aerial vehicle of claim 1, wherein, based on the angle of the side portions, the antenna assembly creates a signal having shaped radiation in a desired direction.

6. The aerial vehicle of claim 5, wherein the angle of the side portions includes a threshold angle between five degrees and sixty degrees.

7. The aerial vehicle of claim 5, wherein the angle of the side portions includes a threshold angle between five degrees and forty-five degrees.

8. The aerial vehicle of claim 5, wherein the side portions comprise concaved-shaped portions, and wherein the angle comprises multiple angles forming a concave shape.

9. The aerial vehicle of claim 1, further comprising a processor coupled to the antenna assembly via the feed cable, wherein the processor is configured to receive a signal from the antenna assembly having shaped radiation in a desired direction based on the angle of the side portions.

10. The aerial vehicle of claim 9, wherein the radiating element comprises a patch antenna element or a helical antenna element, and wherein the signal comprises a signal in a Global Positioning System frequency band.

11. The aerial vehicle of claim 1, wherein:
the antenna assembly further comprises a circuit board having multiple layers, a proximal end, a distal end, a right side, and a left side;
the center portion of the ground plane is positioned on a top layer of the circuit board of the antenna assembly;
a first side portion of the side portions extends from the left side on the top layer of the circuit board; and
a second side portion of the side portions extends from the right side on the top layer of the circuit board.

12. The aerial vehicle of claim 11, wherein the circuit board includes two conductive arms extending a distance in parallel with the center portion of the ground plane, wherein a first conductive arm of the two conductive arms is positioned on the top layer of the circuit board and a second conductive arm of the two conductive arms is positioned on a lower layer of the circuit board relative to the top layer of the circuit board.

13. The aerial vehicle of claim 12, wherein a combination of the radiating element and the ground plane form a patch antenna, and wherein a combination of the ground plane and the two conductive arms form an inverted-F antenna.

14. The aerial vehicle of claim 12, further comprising a processor coupled to the antenna assembly via the feed cable, wherein the processor is configured to receive a first signal from the first conductive arm in a first frequency band and a second signal from the second conductive arm in a second frequency band.

15. The aerial vehicle of claim 14, wherein the first frequency band includes a 980 MHz frequency band, and wherein the second frequency band includes a 1090 MHz frequency band, and wherein dimensions of the first and second conductive arms are selected based on the first and second frequency bands and based on a target impedance.

16. An antenna assembly comprising:
a radiating element coupled to a chassis of an aerial vehicle and positioned in parallel with the chassis;
a substrate coupled to the radiating element;
a ground plane coupled to the substrate; and
a feed cable coupled to the radiating element through the substrate and the ground plane;
wherein the ground plane includes a center portion in parallel with the chassis and with the radiating element, and side portions positioned at an angle relative to the chassis and to the radiating element.

17. The antenna assembly of claim 16, wherein:
the center portion of the ground plane is positioned axially in a different plane relative to the radiating element;
the radiating element overlaps a middle portion of the center portion of the ground plane;
the center portion of the ground plane extends a length and a width greater than the radiating element; and
a width of the side portions of the ground plane is greater than a width of the center portion of the ground plane.

18. The antenna assembly of claim 16, wherein, based on the angle of the side portions, the antenna assembly creates a signal having shaped radiation in a desired direction, wherein the angle of the side portions is greater than five degrees and less than sixty degrees.

19. The antenna assembly of claim 16, further comprising a circuit board having multiple layers, a proximal end, a distal end, a right side, and a left side, wherein:
the center portion of the ground plane is positioned on a top layer of the circuit board of the antenna assembly;
a first side portion of the side portions extends from the left side on the top layer of the circuit board; and
a second side portion of the side portions extends from the right side on the top layer of the circuit board.

20. The antenna assembly of claim 19, wherein:
the circuit board includes two conductive arms extending a distance in parallel with the center portion of the ground plane;
a first conductive arm of the two conductive arms is positioned on the top layer of the circuit board;
a second conductive arm of the two conductive arms is positioned on a lower layer of the circuit board relative to the top layer of the circuit board; and
each of the two conductive arms operates in a frequency band different relative to one another and different relative to the radiating element of the antenna assembly.
